(19) United States
(12) Patent Application Publication
(10) Pub. No.: US 2016/0189259 A1
(43) Pub. Date: Jun. 30, 2016

(54) MANAGING A DISTRIBUTED SECONDARY PRODUCT INVENTORY

(71) Applicant: Jeremy Leigh Cattone, Tigard, OR (US)

(72) Inventor: Jeremy Leigh Cattone, Tigard, OR (US)

(21) Appl. No.: 14/588,038

(22) Filed: Dec. 31, 2014

(51) Int. Cl. G06Q 30/06; G06Q 10/08; G06Q 30/08

(52) U.S. Cl. CPC G06Q 30/0611; G06Q 30/08; G06Q 10/087

(57) ABSTRACT

Systems and methods to manage a secondary distributed product inventory are described. A method includes receiving from a seller of an item, a request to add the item to a secondary auction of items at a network-based marketplace, receiving one or more seller conditions that apply to the item in the secondary auction, identifying the secondary auction based on the item being compatible with other items in the secondary auction, adding the item to the secondary, and notifying the seller in response to receiving an offer from the buyer that satisfies the conditions.

### TECHNICAL FIELD

This disclosure relates to computing and data processing systems. More particularly, systems and methods to manage a distributed secondary product inventory are described.

### RELATED ART

A network-based marketplace typically allows buyers and sellers to buy and/or sell goods and/or services via a network. Such products and/or services that have been made available to a potential buyer may be considered “hard” inventory because as soon as the item is purchased by the buyer, the seller may be committed to provide the item. The item is definitely available to the buyer.

However, in many scenarios, a seller may be somewhat uncommitted regarding the sale of an item. The seller may possess the item, but may not be interested in putting in the effort to make the item available via the network-based marketplace. Buyers looking for the specific item may not be able to find it, and sellers may have difficulty communicating with and/or discovering potential buyers leaving such an item inaccessible.

In one example, a seller may have need for a consumable item and may purchase many of the items at a reduced rate via the network-based marketplace. The seller may plan to consume at least a portion of the items, but may be open to selling some of the items. Of course, the seller may list a portion of the items via the network-based marketplace, but then the seller would be obligated to sell the items leaving them not available for use by the seller. Also, as the seller uses some of the items, the seller would have to consistently adjust availability at the network-based marketplace. Such effort by the seller is inconvenient and inefficient.

### BRIEF DESCRIPTION OF DRAWINGS

Various ones of the appended drawings merely illustrate example embodiments of the present invention and cannot be considered as limiting its scope.

FIG. 1 illustrates one example embodiment of a system for managing a secondary distributed product inventory;

FIG. 2 illustrates one example embodiment of a system for managing a secondary distributed product inventory;

FIG. 3 illustrates one example embodiment of a system for managing multiple divisible items in a secondary distributed product inventory;

FIG. 4 illustrates a computing device that manages a secondary distributed product inventory, according to an embodiment;

FIG. 5 illustrates a method to manage a secondary distributed product inventory, according to an embodiment;

FIG. 6 illustrates a method to manage a secondary distributed product auction, according to an embodiment;

FIG. 7 illustrates a method to manage a secondary distributed product inventory, according to an embodiment;

FIG. 8 illustrates a method to manage sellers for a secondary distributed product inventory, according to an embodiment;

FIG. 9 illustrates a method to manage multiple divisible parts for a secondary distributed product inventory, according to an embodiment;

FIG. 10 illustrates a method to manage a distributed product inventory, according to an embodiment;

FIG. 11 illustrates a method to manage a secondary distributed product inventory, according to an embodiment;

FIG. 12 illustrates a method to manage a distributed product inventory, according to an embodiment;

FIG. 13 is a block diagram of a machine in an example form of a computing system within which a set of instructions for causing the machine to perform any one or more of the methodologies discussed herein may be executed;

FIG. 14 illustrates network architecture 1400, according to an embodiment.

FIG. 15 illustrates a publication system according to an embodiment of the present disclosure; and

FIG. 16 is a high-level entity-relationship diagram, illustrating various tables according to one embodiment of the present disclosure.

### DETAILED DESCRIPTION

The description that follows includes systems, methods, techniques, instruction sequences, and computing machine program products that embody illustrative embodiments of the present disclosure. In the following description, for purposes of explanation, numerous specific details are set forth in order to provide an understanding of an embodiment of the inventive subject matter. It will be evident, however, to those skilled in the art that embodiments of the inventive subject matter may be practiced without these specific details. In general, well-known instruction instances, protocols, structures, and techniques have not been shown in detail.

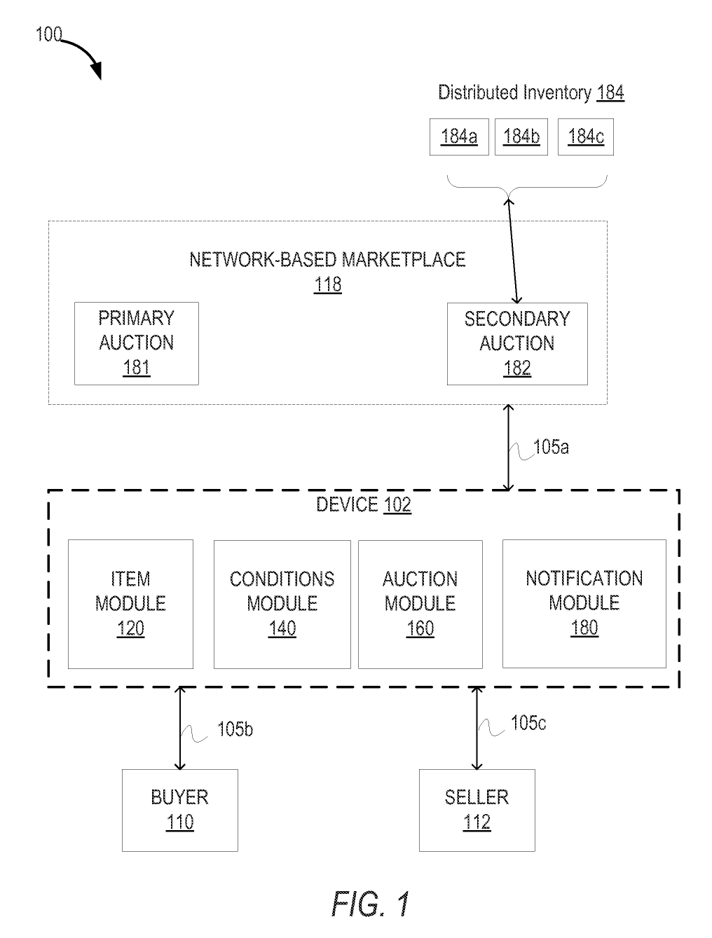

one example embodiment of a system for managing a secondary distributed product inventory, a network-based marketplace (e.g. FIG. 1: 118) may include multiple tiers of auctions. For example, a first tier of auctions includes items that are made available to a potential buyer where the seller is obligated to provide the item in response to the buyer purchasing the item. A first tier of auctions may be a primary tier and a second tier of auctions may be a secondary tier.

In another example, a second tier of auctions includes “soft” items. Soft items, in certain example embodiments, include items that may or may not be available, may be available at uncertain quantities, where availability must be verified by a seller before a transaction may be completed, or similar. In another example, a “soft” item includes an item that is integrated into a pool of similar items so that the seller of the “soft” item is not easily discernible from other sellers of other items in the pool. Although a seller of an item may submit the item to be included in a secondary auction, the seller may subsequently use and/or consume the item. Therefore, although the network-based marketplace may indicate availability of the item, the item may not actually be available due to action by the seller. Availability may be discovered after the offer has been received from a buyer.

In one example embodiment, the second tier of auctions may not be displayed to a buyer unless items in the first tier fail to satisfy conditions of a buyer's offer. Therefore, in response to a primary auction including the item and satisfying conditions received from the buyer, the secondary auction may not be displayed to the buyer. Also, in response to no primary auctions satisfying conditions from the buyer or search criteria from the buyer, the secondary auction may be presented to the buyer.

In another example, items in the second tier of auctions may be displayed after items in the first tier of auctions. Of course, the network-based marketplace may include many more tiers, levels, priority levels, or the like and this disclosure is not limited in this regard.

Therefore, according to systems and methods described in this disclosure, a potential seller of soft items may submit the item to the secondary auction without committing the items for the auction. Thus, the items may be available for purchase via the network-based marketplace, but are also available for the seller to use and/or consume.

The network-based marketplace (FIG. 1: 118) may be an electronic marketplace for purchasing and selling items and services such as eBay of San Jose, Calif. The items sold or purchased on the electronic marketplace 118 may include any item, products, services, or the like as one skilled in the art may appreciate. The network-based marketplace supports electronic commerce services (e.g., search, browse, merchandise, expert services, etc.), as is described in this document.

FIG. 1 illustrates one example embodiment of a system for managing a secondary distributed product inventory. According to this example embodiment, the system 100 includes a network-based marketplace 118 with a primary auction 181 and a secondary auction 182. The secondary auction 182 includes distributed inventory 184 of items available from multiple sellers.

The system 100 also includes a computing device 102 configured to perform one or more of the methods described herein. The device 102 includes an item module 120, a conditions module 140, and an auction module 160. According to this embodiment, the device 102 communicates with at least a buyer 110 and a seller 112.

In one example embodiment, the item module 120 may be configured to receive a request to add an item to a secondary auction of items at the network-based marketplace. In one example, the request includes a description of the item. The description may include properties of the item, color, size, brand, or other, or the like. The description may also include a use state for the item, such as, but not limited to, new, used, returned, or other, or the like. The description may also include a functional description, such as, but not limited to, working, broken, parts only, or other, or the like. The description may also include further item properties, such as, but not limited to, original equipment manufacturer (OEM), after-market, counterfeit, or other, or the like. Of course, one skilled in the art may recognize other description or properties of the item and this disclosure is meant to include all such properties. As described herein, OEM items include items and/or parts that are included in a manufacturer's product as originally supplied to the consumer.

A request to add an item to the secondary auction 182 may include or reference information sufficient to construct a listing for the item. The listing may describe an item that is offered for sale on the network-based marketplace 118. The listing may include a title, a part identifier, a part type identifier, a description, buyer qualifications, preferred buyers, buyers with a social connection to the seller, an image of the item that may be uploaded by the seller, a price to purchase the item that may be configured by the seller, a bid, one or more categories which may be navigated to located and view the listing. The title may be a title of the listing and the description may describe the item. The title and the description may be received from the seller.

The part identifier may include a component/part identifier that identifies the part. The part identifier may be assigned by a manufacturer. The part identifier may include a global trade number (GTIN), a universal product code (UPC), a manufacture part number (MPN) or some other standard product identifier that identifies the item being described. A part identifier may include an alphanumeric identifier or some other identifier that uniquely identifies the part. In another example, the part identifier includes a range of part identifiers. The part identifier may be assigned by a manufacturer or the network-based marketplace 118. In another example, the part identifier includes a standard product identifier (e.g. universal product code (UPC)).

In another example embodiment, the description is limited to an identification of the item, and the item module 120 may determine more specific information. In one example, the identification includes a serial number and the item module 120 determines other product properties based on the serial number. For example, the item module 120 may access a manufacturer's database that includes the additional item properties.

According to one example embodiment, the device 102 communicates with the seller 112 over a communication medium 105c, with the buyer 110 over the communication medium 105b, and with network-based marketplace 118 over communication medium 105a. In one example embodiment, the various communication mediums 105 are network connections, such as, but not limited to, a wired network, a wireless network, an Ethernet network, a coax network, a token ring network, or other network configuration, topology, structure, or the like. Of course, one skilled in the art may recognize other ways in which the item module 120 may receive a description of an item over a communication medium 105c and this disclosure is not limited in this regard.

In another example embodiment, the item module 120 receives a description of an item from the seller 112 via a user interface. In this embodiment, the item module 120 provides one or more buttons, controls, selections, text boxes, or other, or the like. The item module 120 may transmit the user interface to the seller 112 over the communication medium 105c. The seller 112 may indicate the description of the item by selecting and/or manipulating one or more of the controls provided in the user interface.

In another example embodiment, the item may be a long tail item. A long tail item, as described herein and as one skilled in the art may appreciate, includes, but is not limited to, an item that is not within a normal distribution of items. In certain embodiments, long tail items includes unique items, specially configured items, items with unique properties, or other items held back from traditional distribution methods. For example, an item may be a water pump for an automobile, while a long tail item may be a water pump for a 1929 Ford. Therefore, while a water pump for a modern vehicle may be in demand, a water pump for a 1929 Ford likely has very few interested parties. Therefore, a seller of such a water pump would not likely find a buyer at the network-based marketplace. The seller may desire to keep the water pump, but would be open to selling it if an interested party made an offer, however, the effort required to discover the interested party and/or manage the listing likely outweighs the benefit of selling the item. Therefore, a seller of a long-tail item, not having the benefit of this disclosure lacks sufficient motivation to submit the long-tail item to be sold at a network-based marketplace. However, having benefit of this disclosure, the seller may submit the item for sale at the network-based marketplace 118, but may keep the item available for personal use until a qualified buyer comes along.

According to one example embodiment, the item module 120 may receive a description of the item and include a set of long tail items in a secondary auction. A seller of such a set of long tail items may concurrently consume or use one or more of the items without regard to the number of items available in the secondary auction in the network-based marketplace. Providing such a secondary auction 182 allows the device 102, operating as part of the network-based marketplace, to keep records of soft inventory of items and notify the seller in response to receiving an offer that satisfies the conditions under which the item may be sold.

In another example embodiment, the seller may have a user profile at the network-based marketplace 118, and the user profile may indicate one or more items available from the seller. Therefore, the item module 120 may pull information regarding an item to be included in a secondary auction from the user's profile, or other location, or the like.

In one example embodiment, the conditions module 140 is configured to receive one or more seller conditions that apply to the item in the secondary auction 182. Various conditions of the item 184a may include, but is not limited to, a minimum price, a delivery time, continuing availability of the item, and a specific item property. Of course, one skilled in the art may recognize other conditions of a sate and this disclosure is meant to include any and/or all such conditions.

In another example embodiment, the seller 112 may relist purchased items in the secondary auction 182. For example, after purchasing a set of the items via the primary auction 181, the seller 112 may relist one or more of the items in the secondary auction 182. The item module 120 may retrieve details for the secondary auction from the primary auction 181. For example, the item module 120 may copy item images, descriptions, titles, or other information contained in the primary auction 181. Of course, the seller 112 may relist only a portion of the purchased items and this disclosure is not limited regarding the number of items relisted.

In one example embodiment, the auction module 160 may be configured to select a secondary auction 182 for the item based on the item being compatible with the other items in the secondary auction 182. As previously described, the secondary auction 182 may be at a lower priority than a primary auction 181. Furthermore, the secondary auction 182 may be hidden from a buyer 110 of the network-based marketplace until matching items in the primary auction 181 fail to satisfy conditions of an offer received from the buyer.

In one example, the secondary auction includes a distributed inventory 184 of soft items. The secondary auction 182, according to one example embodiment, includes an item 184a from a first seller, an item 184b from a second seller, and an item 184c from a third seller. Therefore, the secondary auction may be an aggregated auction for multiple distributed items that match the item.

In response to receiving a request to add an item to the secondary auction 182, the auction module 160, according to one example embodiment, may select the secondary auction 182 based, at least in part, on mutual or shared compatibility of the item with items already part of the distributed inventory 184.

In one example embodiment, the auction module 160 may configure the secondary auction 182 as a multivariate reverse auction. Multivariate may mean that the secondary auction 182 may include different conditions for different items in the secondary auction 182. For example, item 184a may only accepted by the seller if the price is above a threshold amount, such as, $100, while item 184b may only be accepted by the seller if the price is above $200. Therefore, each of the items in the distributed inventory 184 may include different and/or distinct conditions for a sale.

In another example embodiment, the secondary auction 182 is a reverse auction. According to this embodiment, the reverse auction may not be generally available to the buyer 110, however the buyer 110 may submit an offer to the auction module 160 and the auction module 160 may determine one or more items in the distributed inventory that meet the conditions. A reverse auction, as described herein, may include an auction that accepts buyer bids, and notifies one or more sellers who may accept or reject the bids.

another example embodiment, a buyer may be interested in purchasing an item at a specific price that is lower that what is currently available at the network-based marketplace. A seller may purchase a set of the item at a bulk discount resulting in a price that would satisfy the interests of the buyer, but may only plan to use one half of the items. The seller may be notified, even before purchasing the set of items, that one or more buyers are interested in purchasing the items. Therefore, a potential seller of the item may purchase in bulk, at a reduced price, and have some assurances that other buyers would likely purchase the other half of the items. Combined with a request that the seller relist a portion of the purchased items after purchase, a seller may be more motivated to purchase in bulk providing inventory for the seller and concurrently satisfying a market demand for the item.

In one example embodiment, the notification module 180 may be configured to notify the seller 112 in response to receiving an offer from the buyer that satisfies the seller conditions. For example, after receiving an offer, the notification module 180 may compare conditions or requirements of the offer (e.g. delivery time, price, etc.) to conditions provided by the seller that apply to the item, and notify the seller 112 in response to the conditions of the offer satisfying the seller conditions.

In another example embodiment, the notification module 180 identifies many sellers associated with items satisfied by the offer from the buyer 110. The notification module 180, in one example embodiment, selects a seller with certain qualifications. For example, the notification module 180 may selected a top rated seller, a seller with the most experience with the network-based marketplace, a seller with the higher volume of sales, or other, or the like.

The notification module 180, in another example embodiment, notifies any and/or all sellers with items that match conditions of the over and may wait for responses from one or more sellers. For example, the notification module 180 may award the sale to the seller with the quickest response to the offer, the seller with the lowest price, the seller with the fastest shipping, or other, or the like. In another example embodiment, 180 the notification module 180 may notify the buyer 110 of any and/or all sellers that satisfy conditions of the offer and may request that the buyer select a preferred seller.

In one example embodiment, the notification module 180 may further notify the seller 112 in response to a number of items available via the secondary auction 182 falls below a threshold number. The auction module 160 may reorder matching items from a primary auction 181 if available, or from another supplier, or the like. This may allow the device 102 to maintain a consistent inventory level for the seller 112 without intervention by the seller 112.

Furthermore, the auction module 160, in one embodiment, reads a user profile for the seller to determine current inventory levels and preferred inventory levels and reorders items accordingly. The seller may set preferred inventory levels in his/her profile at the network-based marketplace and the auction module 160 may adjust items included in secondary auction 182, and items purchased in primary auctions 181 to either satisfy a deficiency or sell excess items. Additionally, as previously described, the auction module 160 may satisfy an inventory deficiency by purchasing in bulk, and may purchase more items then necessary to accommodate the deficiency. The auction module 160 may automatically (e.g. without user intervention) relist the excess as previously described.

The following few paragraphs illustrate a specific example according to a non-limiting embodiment. A seller 112 may purchase a set of 10 items, but only plans to use 2 or 3 over the next few months. The seller may then submit 7 of the 10 items to the item module 120 for inclusion in a secondary auction 182. The seller's items may include a specific item condition that the items are OEM items, however, other items in the secondary auction may not be OEM (e.g. aftermarket items) items as previously described.

A buyer 110 may submit a request to the item module 120 for an OEM item that matches the seller's 112 item. In response to no items in the primary auction 181 satisfying the OEM item condition, the notification module 180 may notify the seller 112 that the buyer 110 is interested in purchasing one of the items and may request a response from the seller 112 whether to sell the item according to the conditions of the offer.

However, in one example, the seller 112 may have used all 10 of the items and they are no longer available. In response, the seller may reject the offer. The auction module 160 may, in response, may submit the offer to other sellers until the offer is accepted. In another example, the seller may have used 2 of the 10, and the notification module 180 may notify the seller 112 that an offer has been received for one of the items. The seller 112 may inspect the offer and determine whether to sell at the offer price and/or according to conditions of the offer. The seller 112 may also counter the buyer's 110 offer, provide a message to the buyer 110, or interact with the buyer 110 in other ways as one skilled in the art may appreciate.

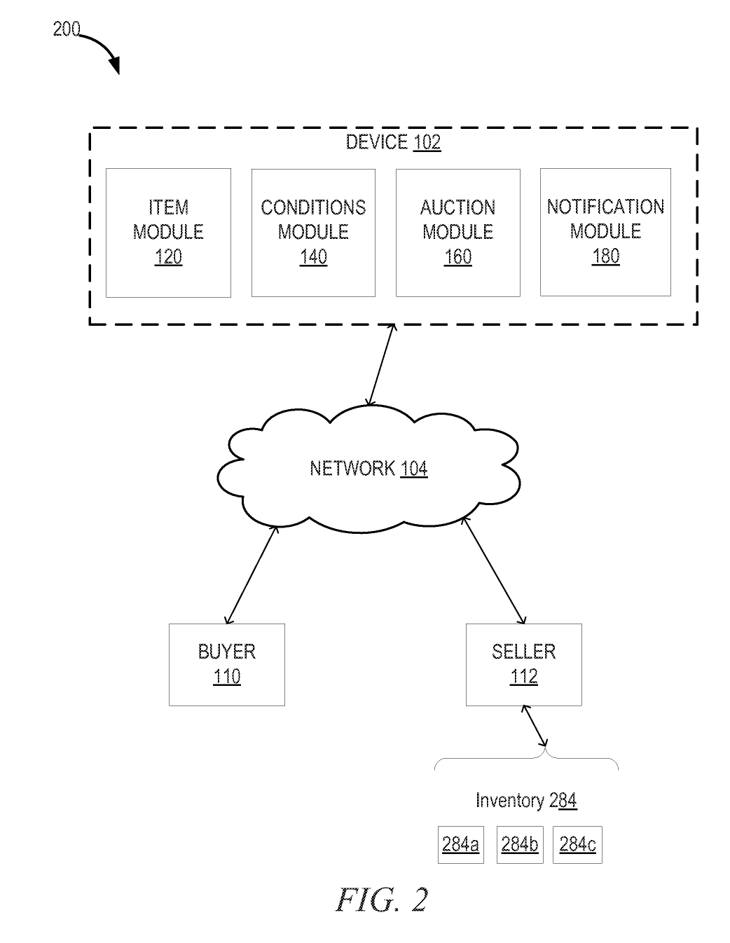

FIG. 2 illustrates one example embodiment of a system 200 for managing a secondary distributed inventory 184 of items. The system 200 may include the device 102, a network 105, the buyer 110 and the seller 112. The seller 112 may keep one or more items 284 that will be made available at a network-based marketplace. The device 102, the buyer 110, and the seller 112 may or may not be substantially similar to those depicted in FIG. 1.

As previously described, the item module 120 may be configured to receive, from a potential seller 112, a request to add an item 284a to a secondary auction of items at a network-based marketplace. According to this embodiment, the auction module 160 may perform substantially similar functions as the network-based marketplace depicted in FIG. 1.

The auction module 160, in this example embodiment, either creates or determines a secondary auction based on the item 284a being compatible with other items in the secondary auction and adds the item to the secondary auction. As depicted in FIG. 2, the buyer 110 and the seller 112 may communicate with the device 102 (e.g. with any of the modules described herein), over the network 104. The network 104 may include any currently available or to be developed network medium, infrastructure, architecture, protocol, or other, or the like. The type of network used to communicate between the device 102 and either the buyer 110 or the seller 112 is not limited in this regard. In one specific example, the network 104 is the Internet.

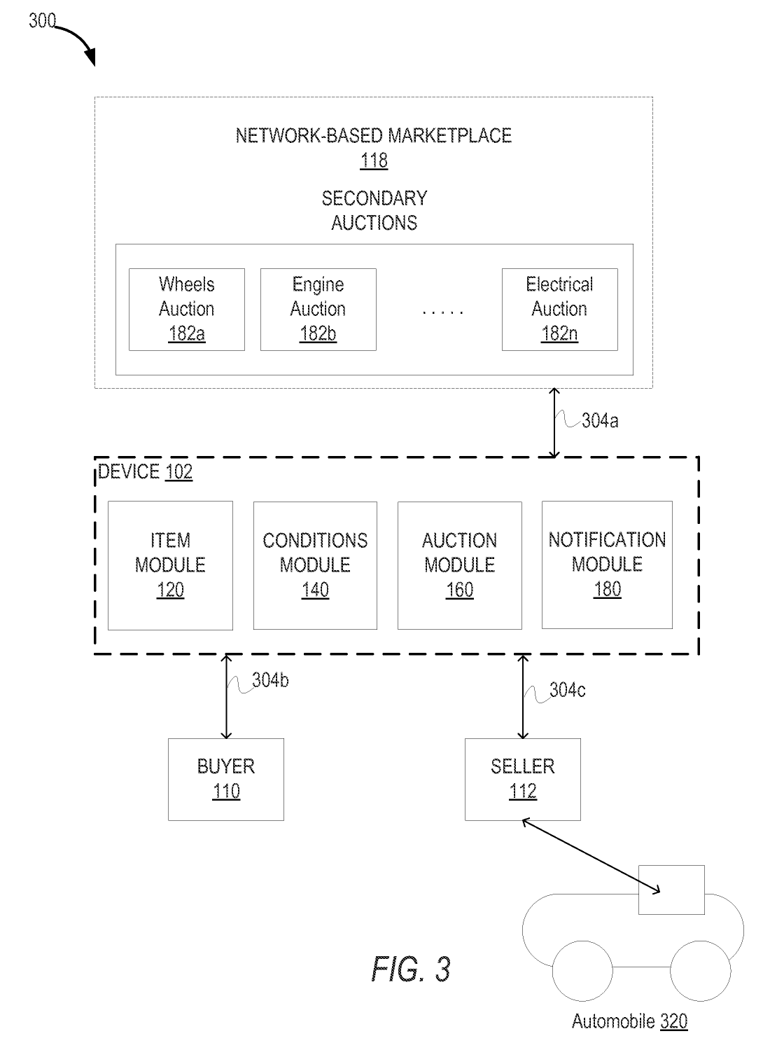

FIG. 3 illustrates one example embodiment of a system 300 for managing multiple divisible items in a secondary distributed product inventory. The system 300 may include the device 102, the network-based marketplace 118, the buyer 110 and the seller 112. The network-based marketplace 118, the device 102, the buyer 110 and the seller 112 may or may not be substantially similar to those depicted in FIG. 1.

In one example embodiment, the buyer 110 is a computing device for a human buyer. The buyer 110, in this example embodiment, includes a mobile computing device that interacts with the human buyer to communicate with one or more of the modules described herein, and included in the device 102. Similarly, the seller 112 may include a computing device associated with a human seller 112 or a computing device that may submit one or more items for sale via the network-based marketplace 118.

In another example embodiment, executable code operating at the buyer 110 and/or the seller 112 may utilize an Application Program Interface (API) to communicate with any of the modules described relating to the device 102. In another example embodiment, the modules described may operate as a web sen/or and provide programmatic and web interfaces respectively to the buyer 110 and/or the seller 112.

In another example embodiment, the seller 112 may submit an item 320 for sale including multiple divisible parts. Divisible parts, as described herein, may include parts that a mechanic skilled in the art may disassemble using ordinary tools. According to this specific example, the item 320 is an automobile. As one skilled in the art may appreciate, the automobile includes many divisible parts, such as, but not limited to, tires, rims, wheels, engines, electrical parts, sensors, brakes, windows, interior parts, gauges, knobs, handles, transmission, other driveline parts, or other parts, or the like. Of course, one skilled in the art may recognize other divisible parts and this disclosure is meant to include all such parts.

According to one embodiment, the item 320 includes many divisible parts, and the item module 120 may generate a list of parts associated with the item. The auction module 160 may add the divisible parts to separate and distinct secondary auctions 182. For example, the auction module 160 may add the wheels to a wheels secondary auction 182a, an engine to a secondary engine auction 182b, electrical parts to an electrical secondary auction 182n, and other parts to other similar auctions.

In one example embodiment, the seller 112 may provide different conditions for each of the multiple parts, but of course, this is not necessarily the case. For example, the seller 112 may indicate that interior parts will be shipped within one day after an order whereas an engine may take much longer to ship. Therefore, a seller 112 may place an item for sate via the network-based marketplace and may only need to disassemble the part in response to an actual order.

Furthermore, the communication mediums 304 in one example embodiment includes any of the aforementioned network transmission mediums or the Internet, or other, or the like as one skilled in the art may appreciate.

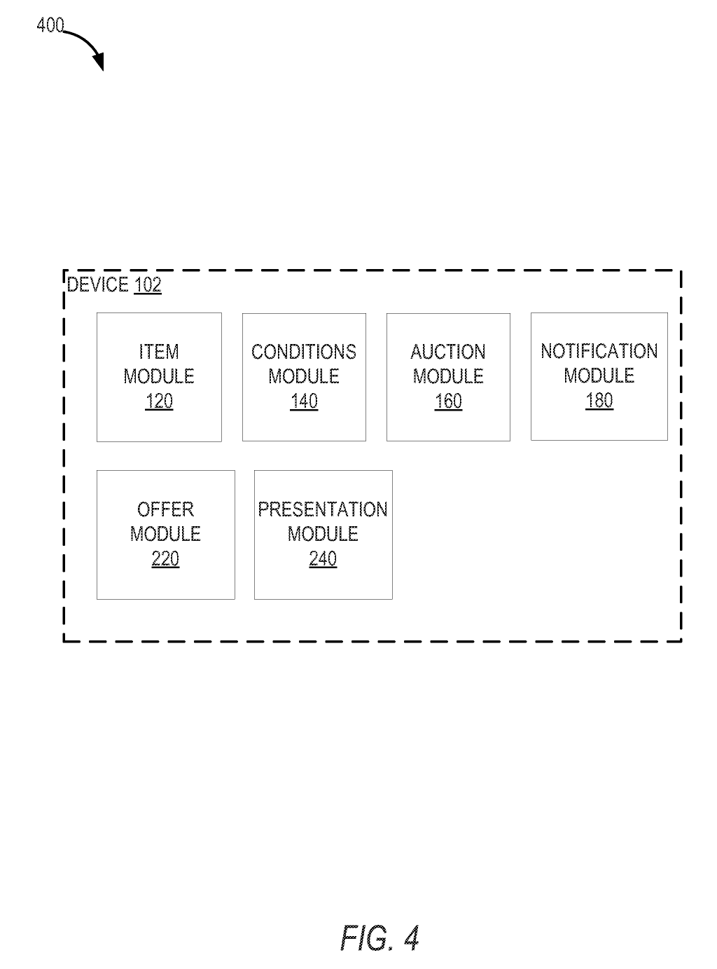

FIG. 4 illustrates a computing device 400 that manages a secondary distributed product inventory, according to an embodiment. The computing device 400 includes the item module 120, the conditions module 140, the auction module 160, the notification module 180, an offer module 220, and a presentation module 240. The item module 120, the conditions module 140, the auction module 160, and the notification module 180 may or may not be substantially similar to those depicted in FIG. 1-3.

In one example embodiment, the offer module 220 is configured to receive an offer from a buyer 110. The offer module 220 may determine whether the offer satisfies seller conditions. For example, a seller condition may include the item being shipped within one week. In response to the buyer indicating that the item must be shipped same day, the offer module 220 may decline the offer because the offer does not satisfy one of the seller conditions. Therefore, in certain embodiments, the offer includes one or more buyer conditions. For example, the buyer may indicate a specific shipment time, a maximum price, an item state (e.g. new, used, returned, etc.), an item condition (e.g. brand, size, color, OEM, etc.), or other, or the like. Of course, one skilled in the art may recognize other conditions and/or properties of the item and a buyer condition may include such a condition.

In another example embodiment, a first seller may have 5 of the item at $100 each and a second seller may have 5 of the items available at $120 each. In response to receiving a bid for 10 of the items at $110/each, the auction module 160 may divide the offer into separate offers for the two sellers to accommodate the different prices. For example, the auction module 160 may generate an offer to the first seller for 5 items at $100 each, and an offer to the second seller for 5 items at $120 each. Therefore, the auction module 160 may submit altered offers to different sellers. They buyer would not be privy to the altered offers, and the sellers would not be privy to the original offer from the buyer. Such a modification by the offer module may facilitate increased buying and selling in the network-based marketplace.

In another example embodiment, the offer module 220 may give higher value sellers better offers. For example, and based on the previous example, in response to the first seller having a higher volume of total sales than the second seller, the offer module may generate at the network-based marketplace, the offer module 220 may generate an offer to the first seller for 5 of the items at $105 each and an offer to the second seller at $115 each.

In another example, the buyer conditions include properties of a seller 112. For example, a buyer condition may indicate that the buyer will only purchase from sellers with a minimum feedback rating, a minimum number of transactions, seller expertise in a certain subject, other seller qualifications, or the like. Furthermore, a buyer condition may include a specific identification of a seller such that the offer is only transmitted to the specific identified seller.

In one example embodiment, the auction module 160 may determine one or more properties of a seller from a seller's user profile at the network-based marketplace 118. The user profile information may include user information, user preference information, and information regarding favorite items, or the like. The user information may store the name, address, telephone number, and other information.

In another example embodiment, the auction module 160 periodically determines properties of a seller. In another example embodiment, the auction module 160 periodically requests the seller 112 to verify availability of an item. Because the item may be considered “soft” inventory, the item may or may not be available at the time the buyer 110 submits the offer to the seller 112.

In another example embodiment, the seller 112 may no longer need and/or want the items in the soft inventory. In response, the seller 112 may indicate to convert the “soft” items to “hard” items. In response, the auction module 160 converts the secondary auction to a primary auction making the items immediately available to would-be purchasers.

In one example embodiment, the auction module 160 may detect that a matching item has been added to a primary auction at the network-based marketplace and the notification module 180 may notify the seller 112 that the item is available in a primary auction. Such a notification allows a seller to maintain a local inventory of the item, control supply of the item, or the like as one skilled the art may appreciate.

In one example embodiment, the presentation module 240 is configured to display the secondary auction to the buyer in response to receiving an offer that satisfies the seller conditions. The presentation module 240 may display the offer to the buyer via any type of display as one skilled in the art may appreciate. In another example embodiment, the presentation module 240 causes a remote system to display the secondary auction. In one example, the presentation module 240 notifies the network-based marketplace that the secondary auction may be exposed to the buyer.

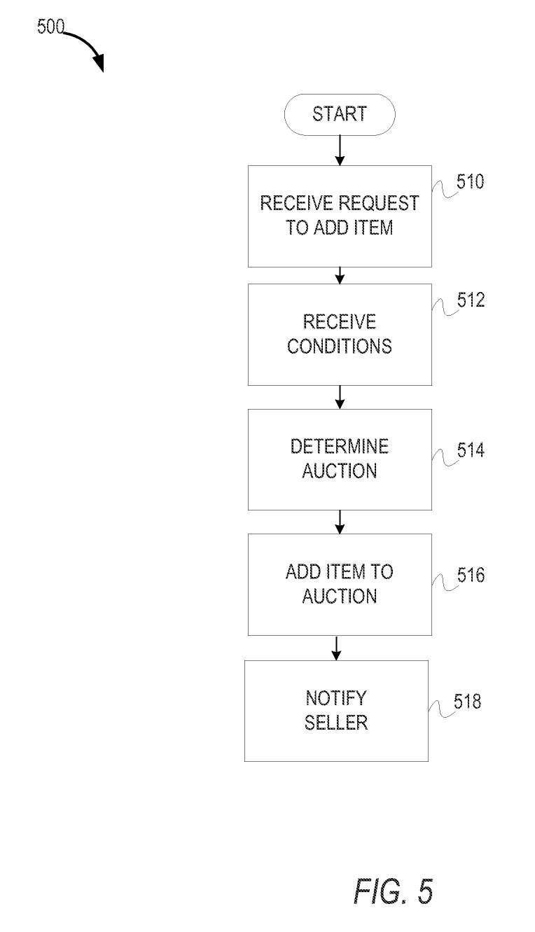

FIG. 5 illustrates a method 500 to manage a secondary distributed product inventory, according to an embodiment. The method 500 may commence at operation 510, with the item module 120 receiving a request to add an item to a secondary auction of items at a network-based marketplace. At operation 510, the item module 120 may receive messages, network packets, images, or other media content to identify the item. The method 500 may continue at operation 512 with the conditions module 140 receiving one or more seller conditions that apply to the item in the secondary auction. As previously described, the seller conditions may include, but are not limited to, price, delivery time, continuing availability, and/or a specific item property.

The method 500 may continue at operation 514 with the auction module 160 identifying the secondary auction based on the item being compatible with other items in the secondary auction. In another example embodiment, the auction module 160 may create the secondary auction in response to no secondary auctions existing for compatible items.

The method 500 may continue at operation 516 with the auction module 160 adding the item to the secondary auction. In one example embodiment, the secondary auction is an auction for the single item indicated by the seller. In another example embodiment, the auction module 160 adds the item to an already existing secondary auction thereby aggregating items from multiple sellers into one secondary auction. The method 500 may continue at operation 518 with the notification module 180 notifying the seller in response to receiving an offer from a buyer that satisfies the seller conditions.

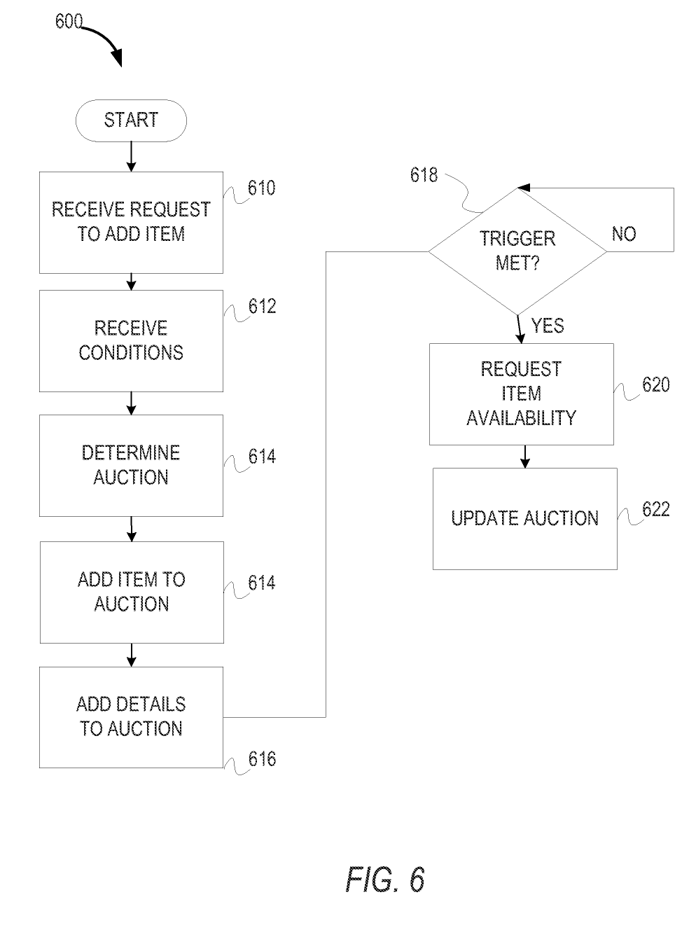

FIG. 6 illustrates a method 600 to manage a secondary distributed product auction, according to an embodiment. The method 600 may commence at operation 610, with the item module 120 receiving a request to add an item to a secondary auction of items at a network-based marketplace. The method 600 may continue at operation 612 with the conditions module 140 receiving one or more seller conditions that apply to the item in the secondary auction. The method 600 may continue at operation 614 with the auction module 160 may identify secondary auction based on the item being compatible with other items in the secondary auction.

The method 600 may continue at operation 616 with the auction module 160 adding details to the auction. According to one example embodiment, the auction module 160 may determine a previous auction used by the seller to purchase the items and may pull item details from the previous auction to add to the secondary auction. Also, the auction module 160 may retrieve auction details from auctions for other auctions selling compatible items. Furthermore, the auction module 160 may reactivate a previous auction for one or more of the items. For example, in response to the seller purchasing all of the items in an auction, the auction module 160 may simply update the auction to accommodate the current seller instead of the previous seller. Therefore, in this embodiment, the auction module 160 may not make a new auction for the items, but may reuse or add to an existing auction.

The method 600 may continue at operation 618 with the auction module 160 determining whether a time threshold has passed, or if another triggering mechanism is met. In one example, the auction module 160 may receive a time threshold from the seller that indicates when to request item availability. Because items in a secondary auction of items may include “soft” items, the items may be used by the seller, or may be otherwise unavailable. Therefore, according to the method 600, the auction module 160 periodically requests item availability to facilitate accurate information in the secondary auction regarding items that are available. In one example, the time period is 1 day. In another example, the time period is one week. Of course, one skilled in the art may recognize other time periods and this disclosure is not limited in this regard.

In response to determining that the time threshold has not passed, the method 600 continues at operation 618 with the auction module 160 again determining whether the time threshold has been passed. In response to the auction module 160 determining that the time threshold has passed, the notification module 180 may request item availability from the seller. The method 500 may continue at operation 622 with the auction module 160 updating the secondary auction based on a response from the seller.

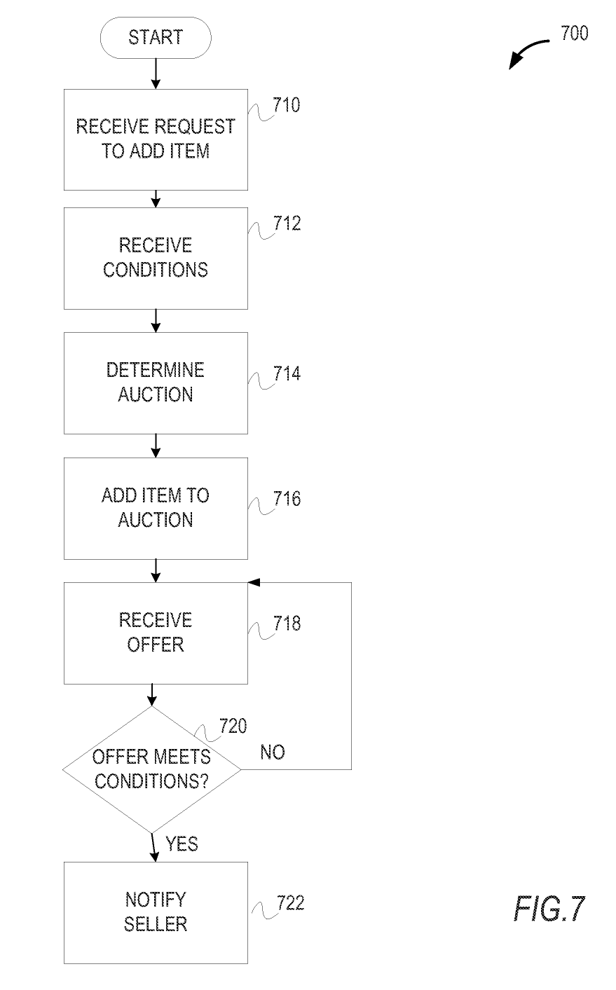

FIG. 7 illustrates a method 700 to manage a secondary distributed product inventory, according to an embodiment. The method 700 may commence at operation 710, with the item module 120 receiving a request to add an item to a secondary auction of items at a network-based marketplace. The method 700 may continue at operation 712 with the conditions module 140 receiving one or more seller conditions that apply to the item in the secondary auction. The method 700 may continue at operation 714 with the auction module 160 identifying the secondary auction based on the item being compatible with other items in the secondary auction.

The method 700 may continue at operation 716 with the auction module 160 adding the item to the auction as previously described. The method 700 may continue at operation 718 with the offer module 220 receiving an offer from the buyer. The offer module 220 may determine, at operation 720, whether the offer satisfies the seller conditions. In response to the offer not satisfying the seller conditions, the method 700 continues at operation 718 with the offer module 220 receiving another offer. In response to the offer satisfying the seller conditions, the method 700 continues at operation 722 with the notification module 180 notifying the seller.

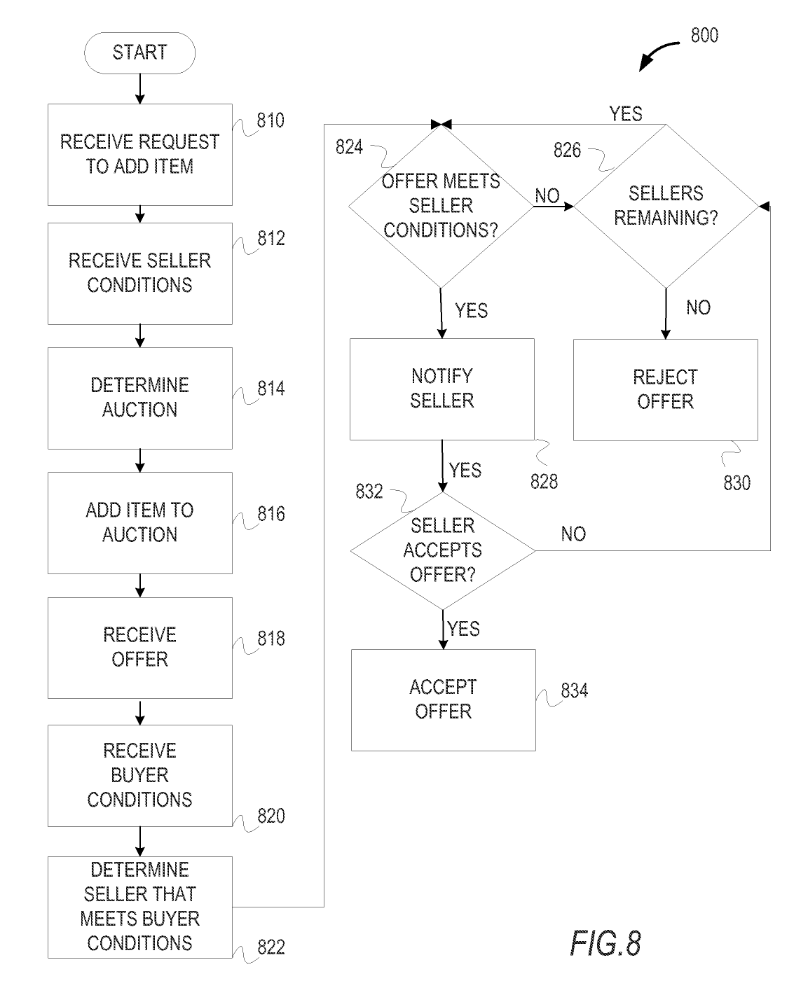

FIG. 8 illustrates a method 800 to manage sellers for a secondary distributed product inventory, according to an embodiment. The method 800 may commence at operation 810, with the item module 120 receiving a request to add an item to a secondary auction of items at a network-based marketplace. The method 800 may continue at operation 812 with the conditions module 140 receiving one or more seller conditions that apply to the item in the secondary auction. The method 800 may continue at operation 814 with the auction module 160 identifying the secondary auction based on the item being compatible with other items in the secondary auction.

The method 800 may continue at operation 816 with the auction module 160 adding the item to the auction as previously described. The method 800 may continue at operation 818 with the offer module 220 receiving an offer from the buyer. The method 800 may continue at operation 820 with the conditions module 140 receiving one or more buyer conditions.

In one example embodiment of the method 800, the auction module 160 identifies one or more sellers that satisfy the buyer conditions. As previously described, the buyer conditions may restrict sellers that do not meet certain characteristics. For each of the sellers that meet the buyer conditions, the auction module 160, at operation 824, identifies whether the offer received from the buyer meets the seller's conditions. In response to the offer failing to satisfy the seller's conditions, the method 800 may continue at operation 826 with the auction module 160 determining whether there are additional sellers. In response to there being no additional sellers, the method 800 continues at operation 830 with the offer module 220 rejecting the offer.

In response to the auction module 160 determining that there are additional sellers, the auction module 160 may continue at operation 824 with the auction module 160 determining whether the offer meets the next seller's conditions. In response to the offer meeting the seller's conditions, the method 800 continues at operation 828 with the notification module 180 notifying the seller.

The method 800 may continue at operation 832 with the notification module 180 determining whether the seller accepts the offer. The notification module 180 may determine whether the seller accepts the offer by receiving a message, receiving network packets, via a user interface, lack of a response, or other, as one skilled in the art may appreciate. In response to determining that the seller does not accept the offer, the method continues at operation 826 with the auction module 160 determining whether there are additional sellers. In response to determining that the seller does accept the offer, the method continues at operation 834 and the auction module 160 accepts the offer.

In another example embodiment, the buyer may submit an offer to purchase one or more items from the secondary auction and the auction module 160 determines one or more sellers to forward the offer to. As previously described, the offer module 220 may determine one or more sellers to accommodate the buyer's offer. For example, where the offer requests 10 items and a first seller has five items and a second seller has five items, the offer module 220 contacts the first seller and the second seller to satisfy the offer for 10 items. Therefore, the buyer need not be aware that there are in fact multiple sellers providing the requested items, and may not deal with any of the sellers directly.

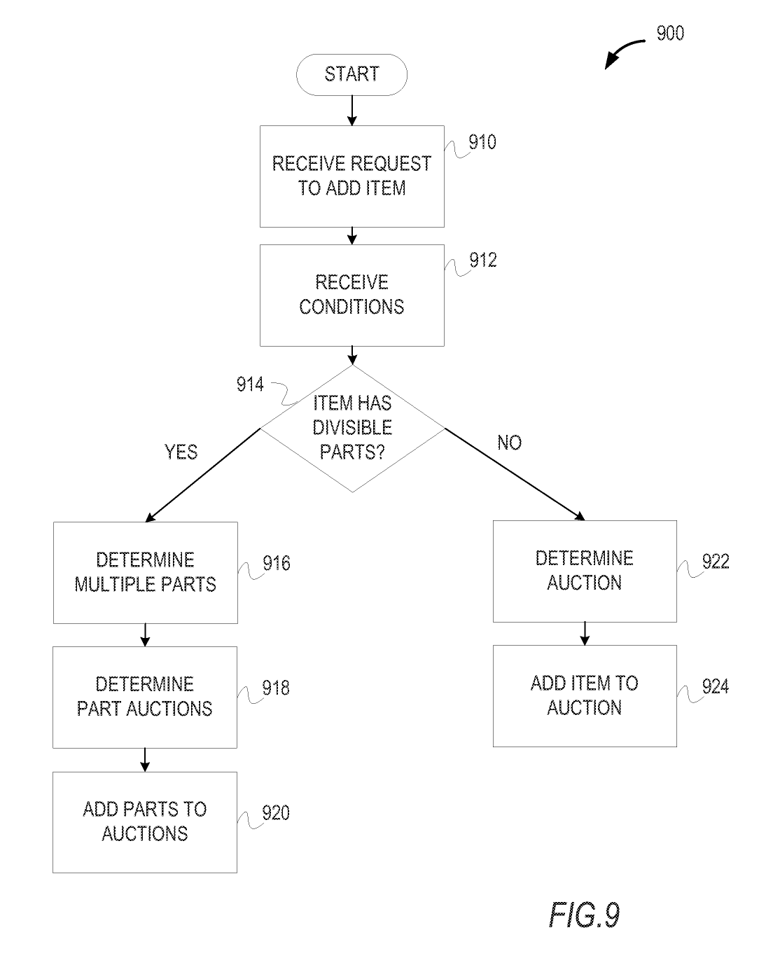

FIG. 9 illustrates a method 900 to manage multiple divisible parts for a secondary distributed product inventory, according to an embodiment. The method 900 may commence at operation 910, with the item module 120 receiving a request to add an item to a secondary auction of items at a network-based marketplace. The method 900 may continue at operation 912 with the conditions module 140 receiving one or more seller conditions that apply to the item in the secondary auction. The method 900 may continue at operation 914 and the item module 120 may determine whether the item has multiple divisible parts. In another example embodiment of the method 900, the method includes asking the seller whether to add the multiple parts to their respective auctions, or whether the seller would prefer to sell the item as a whole.

In response to determining that the item does not have multiple divisible parts, the method 900 continues at operation 922 and the auction module 160 determines the secondary auction based on the item being compatible with other items in the secondary auction. The method 900 continues at operation 924 and the auction module 160 adds the item to the secondary auction.

In response to determining that the item does have multiple divisible parts, the method continues at operation 916 with the item module 120 dividing the item into its multiple divisible parts. The method 900 continues at operation 918 with the auction module 160 identifying respective auctions for the multiple parts. The method 900 continues at operation 920 and the auction module 160 adds the multiple parts to the respective auctions.

According to this method 900, a seller may submit a large item with many multiple divisible parts for inclusion in a secondary auction. The item module 120 may divide the item into its respective parts and the auction module 160 may add the parts to their respective auctions. Because the respective parts may or may not be available, in a proper working condition, or the like, the item module 120 may designate the multiple parts as “soft” items.

In another example embodiment, the auction module 160 may concurrently list the large item as a single item. In response, to a buyer purchasing the large item, the method 900 may include removing the secondary auctions for each of the divisible items. Also, in response to a buyer purchasing one or more of the divisible items, the method 900 may include updating a status of the large item to indicate that the sold parts are missing from the large item.

Potential buyers and/or others who may desire one or more of the multiple parts may query the device 102 for needed parts. In response to not finding items in primary auctions, the auction module 160 may disclose the soft item to the buyer. Although availability of the item may be uncertain, the offer module 220 receives an offer for one of the multiple parts and the notification module 180 notifies the seller that a buyer desired the indicated part response, the offer module 220 may receive an indication from the seller whether or not to sell the part, or may receive one or more additional conditions for the sale which the buyer may or may not accept.

In a specific non-limiting example, the seller may collect rare vehicles (and therefore rare parts for the rare vehicles). The seller may submit one of the rare vehicles for inclusion in a secondary auction. As previously described, the item module 120 may divide the vehicle into several divisible parts and may add the parts to different auctions based on the parts matching items in the secondary auctions. Of course, the individual parts may or may not be available based, at least in part, on the condition of the rare vehicle.

According to this embodiment, a buyer may be searching for one of the specific rare parts and may query the network-based marketplace for the rare parts. In response to no primary auctions including the rare parts. For example, the buyer may specifically request OEM parts and the primary auctions may only include after-market parts. In response, the auction module 160 may expose the secondary “soft” rare parts to the buyer and the buyer may submit an offer for one of the rare parts. The notification module 180 may then notifies the seller that an offer has been received and the seller may respond as desired.

In this embodiment, a seller of the rare parts, need not inventory each of the rare parts, need not make a list of available parts, and would only be requested to determine an actual status of the rare part based on the buyer's offer. Therefore, a seller of such items does not need to waste time dealing with the rare parts until a buyer has demonstrated sufficient interest. Furthermore, in response to the seller examining one of the rare parts, and determining that the rare part is not fit for sale, the item module 120 may remove the rare part from the secondary auction.

In another example embodiment, the auction module 160 may store the multiple divisible parts of an item in a hierarchy of parts as one skilled in the art may appreciate. For example, the rare item may be a vehicle, and the rare parts may be included in categories for the vehicle, such as, but not limited to, electrical, suspension, drive line, engine, transmission, glass, interior, sensors, or the like.

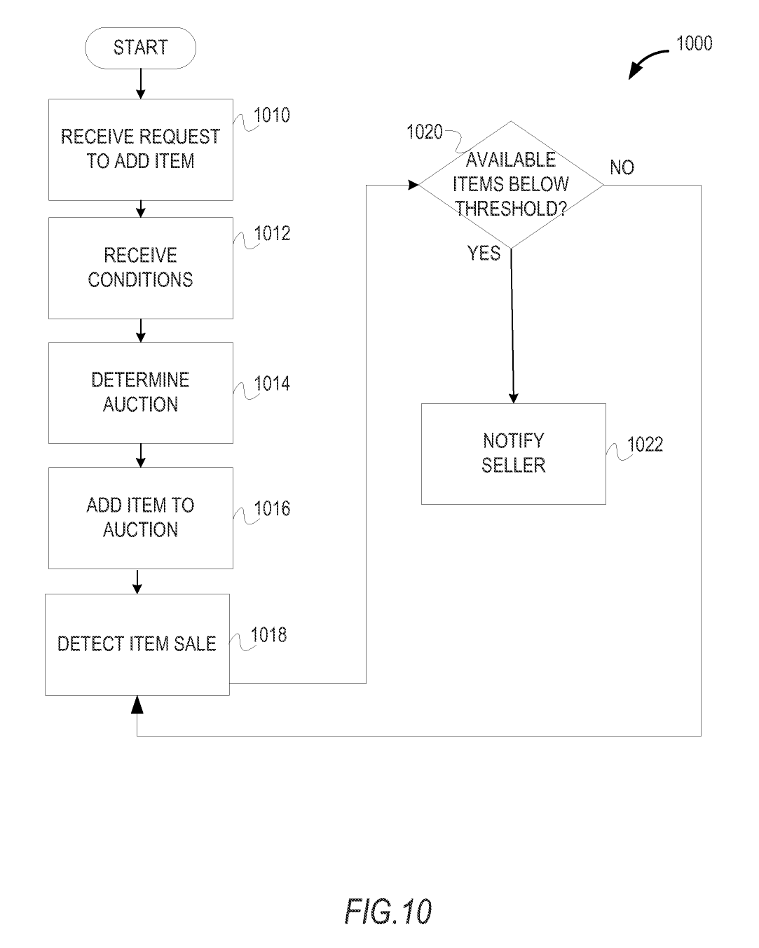

FIG. 10 illustrates a method 1000 to manage a distributed product inventory, according to an embodiment. The method 1000 may commence at operation 1010, with the item module 120 receiving a request to add an item to a secondary auction of items at a network-based marketplace. The method 1000 may continue at operation 1012 with the conditions module 140 receiving one or more seller conditions that apply to the item in the secondary auction. The method 1000 may continue at operation 1014 with the auction module 160 identifying the secondary auction based on the item being compatible with other items in the secondary auction.

The method 1000 continues at operation 1016 with the auction module 160 adding the item to the secondary auction. The method 1000 continues at operation 1018 and the item module 120 may detect a sale of one of the items in the secondary auction of items. The method 1000 continues at operation 1020 with the auction module 160 determining whether a number of items remaining in the secondary auction is below a threshold number.

In response to the remaining number of items not being below the threshold number, the method 1000 may continue at operation 1018 with the auction module 160 detecting another sale of an item in the secondary auction. In response to the remaining number of items being below the threshold number, the method 1000 continues at operation 1022 with the notification module 180 notifying the seller. In response, the seller may increase a number of items available via the secondary auction. In another example embodiment, the notification module 180 may notify the seller in response to the number of items available from the seller fall below the threshold number.

In one specific non-limiting example, the item may be a gasket and the seller may have 10 of them. The seller may indicate that 5 are available via the secondary auction and may request a notification in response to the number available in the secondary auction falling below two.

In another example embodiment, the auction module 160 may receive from the seller a threshold number of items to be maintained in the seller's inventory of items. In response to a buyer purchasing one or more of the items in the secondary auction, the auction module 160 may reorder, without user intervention, items from other sources to cover the loss due to items being sold in the secondary auction.

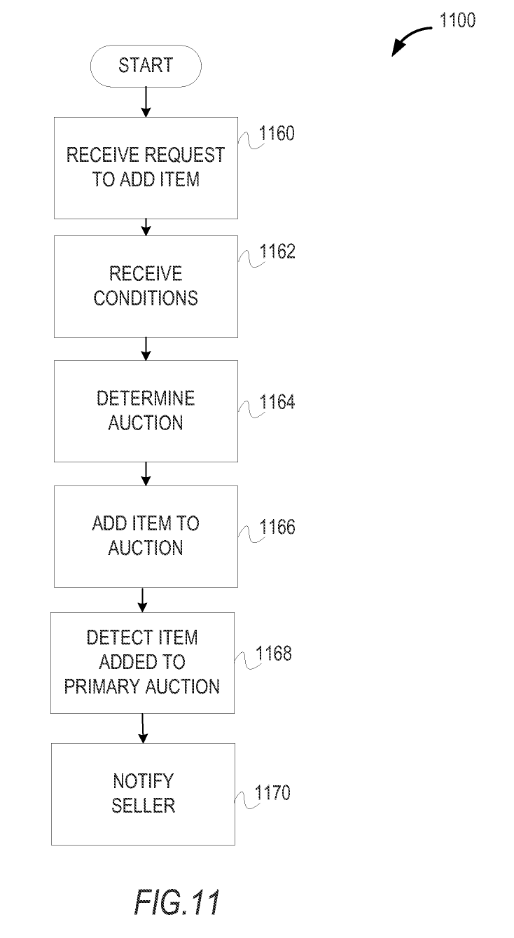

FIG. 11 illustrates a method 1100 to manage a secondary distributed product inventory, according to an embodiment. The method 1100 may commence at operation 1160, with the item module 120 receiving a request to add an item to a secondary auction of items at a network-based marketplace. The method 1100 may continue at operation 1162 with the conditions module 140 receiving one or more seller conditions that apply to the item in the secondary auction. The method 1100 may continue at operation 1164 with the auction module 160 identifying the secondary auction based on the item being compatible with other items in the secondary auction.

The method 1100 continues at operation 1166 with the auction module 160 adding the item to the secondary auction. The method 1100 continues at operation 1168 with the auction module 160 detecting that a matching item has been added to a primary auction at the network-based marketplace. The method 1100 continues at operation 1170 with the notification module 180 notifying the seller that the matching item had been added to the primary auction.

The seller may purchase the matching items in the primary inventory in order to restock a local inventory of items that may be made available in the secondary auction. Furthermore, the seller may restrict access to items that match the item by purchasing all available items in one or more primary auctions. Such actions by the seller may further increase the value of the items in the secondary auction.

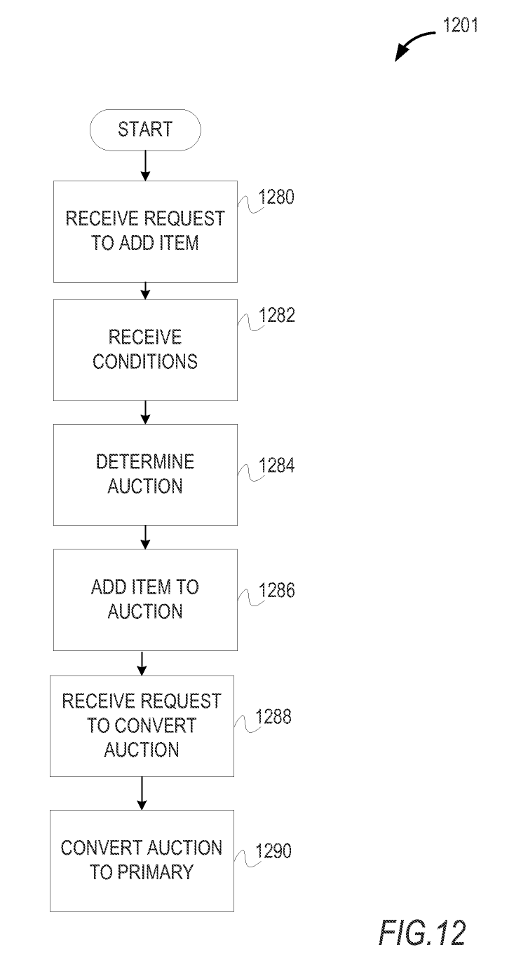

FIG. 12 illustrates a method 1201 to manage a distributed product inventory, according to an embodiment. The method 1201 may commence at operation 1280, with the item module 120 receiving a request to add an item to a secondary auction of items at a network-based marketplace. The method 1201 may continue at operation 1282 with the conditions module 140 receiving one or more seller conditions that apply to the item in the secondary auction. The method 1201 may continue at operation 1284 with the auction module 160 identifying the secondary auction based on the item being compatible with other items in the secondary auction.

The method 1201 continues at operation 1286 with the auction module 160 adding the item to the secondary auction. The method 1201 continues at operation 1288 with the auction module 160 receiving a request from the seller to convert the secondary auction to a primary auction. The method 1201 continues at operation 1290 with the auction module 160 converting the secondary auction to a primary auction.

Such a conversion of the secondary auction converts “soft” items to “hard” items. Accordingly, the items may be available to a buyer of the network-based marketplace without requiring approval from a seller of the item.

### Machine

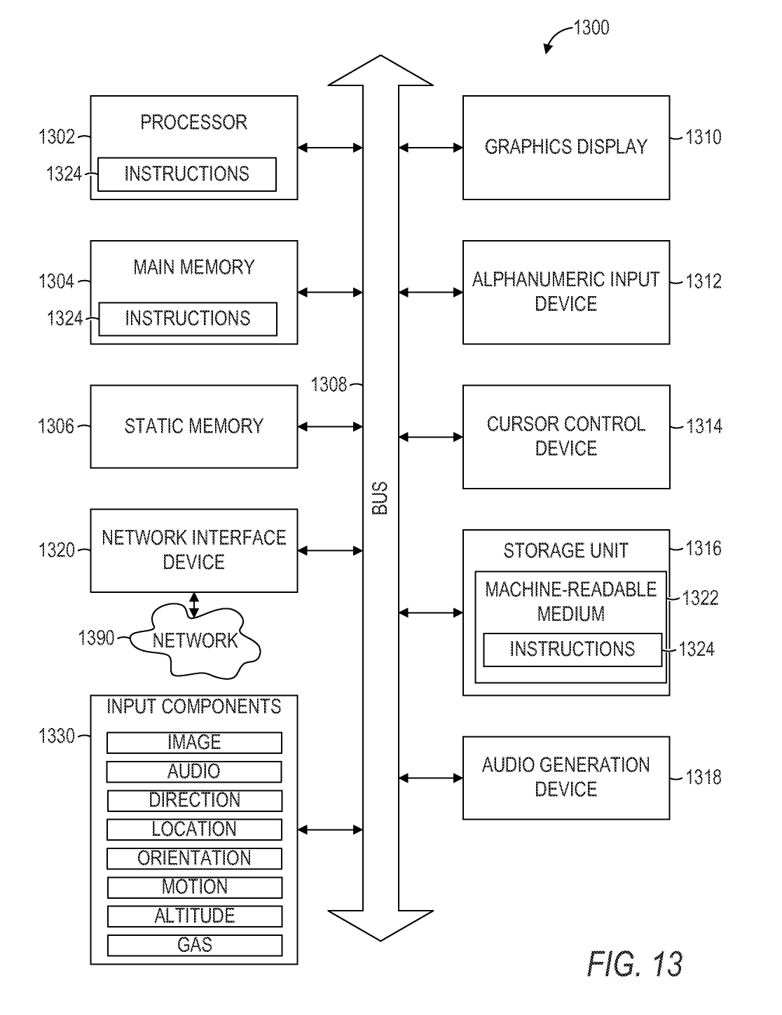

FIG. 13 is a block diagram of a machine in an example form of a computing system within which a set of instructions for causing the machine to perform any one or more of the methodologies discussed herein may be executed. Specifically, FIG. 13 shows the machine 1300 in the example for of a computer system (e.g., a computer) within which the instructions 1324 (e.g., software, a program, an application, an applet, an app, or other executable code) for causing the machine 1300 to perform any one or more of the methodologies discussed herein may be executed, in whole or in part. In alternative embodiments, the machine 1300 operates as a standalone device or may be connected (e.g., networked) to other machines. In a networked deployment, the machine 1300 may operate in the capacity of a server machine or a client machine in a server-client network environment, or as a peer machine in a distributed (e.g., peer-to-peer) network environment. The machine 1300 may be a server computer, a client computer, a personal computer (PC), a tablet computer, a laptop computer, a netbook, a cellular telephone, a smartphone, a set-top box (STB), a personal digital assistant (FDA), a web appliance, a network router, a network switch, a network bridge, an engine control unit, integrated vehicle entertainment and information system (e.g., in-dash navigation+information+radio controller), or any machine capable of executing the instructions 1324, sequentially or otherwise, that specify actions to be taken by that machine. Further, while only a single machine is illustrated, the term “machine” shalt also be taken to include any collection of machines that individually or jointly execute the instructions 1324 to perform all or part of any one or more of the methodologies discussed herein.

The machine 1300 includes a processor 1302 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1304, and a static memory 1306, which are configured to communicate with each other via a bus 1308. The processor 1302 may contain microcircuits that are configurable, temporarily or permanently, by some or all of the instructions 1324 such that the processor 1302 is configurable to perform any one or more of the methodologies described herein, in whole or in part. For example, a set of one or more microcircuits of the processor 1302 may be configurable to execute one or more modules (e.g., software modules) described herein.

The machine 1300 may further include a graphics display 1310 (e.g., a plasma display panel (PDP), a light emitting diode (LED) display, a liquid crystal display (LCD), a projector, a cathode ray tube (CRT), or any other display capable of displaying graphics or video). The machine 1300 may also include an alphanumeric input device 1312 (e.g., a keyboard or keypad), a cursor control device 1314 (e.g., a mouse, a touchpad, a trackball, a joystick, a motion sensor, an eye tracking device, or other pointing instrument), a storage unit 1316, an audio generation device 1318 (e.g., a sound card, an amplifier, a speaker, a headphone jack, or any suitable combination thereof), and a network interface device 1320. The network interface device 1320 may be used by one or more of the modules described herein to communicate with the buyer 110, the seller 112, the network 104, or similar, or the like. The presentation module 240 may display the secondary auction to a buyer using the graphics display 1310.

The storage unit 1316 includes the machine-readable medium 1322 (e.g., a tangible and non-transitory machine-readable storage medium) on which are stored the instructions 1324 embodying any one or more of the methodologies or functions described herein. The instructions 1324 may also reside, completely or at least partially, within the main memory 1304, within the processor 1302 (e.g., within the processor's cache memory), or both, before or during execution thereof by the machine 1300. Accordingly, the main memory 1304 and the processor 1302 may be considered machine-readable media (e.g., tangible and non-transitory machine-readable media). The instructions 1324 may be transmitted or received over the network 1390 via the network interface device 1320. For example, the network interface device 1320 may communicate the instructions 1324 using any one or more transfer protocols (e.g., hypertext transfer protocol (HTTP)).

In some example embodiments, the machine 1300 may be a portable computing device, such as a smart phone or tablet computer, and have one or more additional input components 1330 (e.g., sensors or gauges). Examples of such input components 1330 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components 1330 may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1322 is shown in an example embodiment to be a single medium, the term “machine-readable medium” should be taken to include a single medium or multiple media (e.g., a centralized or distributed database, or associated caches and servers) able to store instructions 1324. The term “machine-readable medium” shall also be taken to include any medium, or combination of multiple media, that is capable of storing the instructions 1324 for execution by the machine 1300, such that the instructions 1324, when executed by one or more processors of the machine 1300 (e.g., processor 1302), cause the machine 1300 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Furthermore, the machine-readable medium is non-transitory in that it does not embody a propagating signal. However, labeling the tangible machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

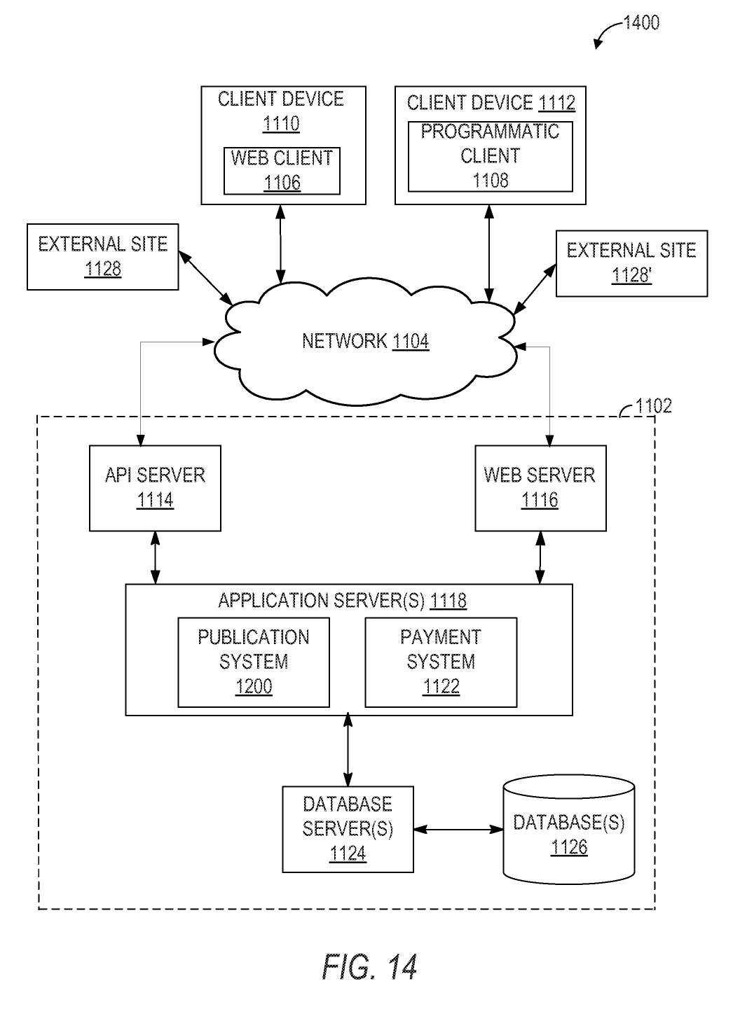

FIG. 14 illustrates network architecture 1400, according to an embodiment. A networked system 1102, in an example form of a network-server-side functionality, is coupled via a communication network 1104 (e.g., the Internet, wireless network, cellular network, or a Wide Area Network (WAN)) to one or more client devices 1110 and 1112. The networked system 1102 corresponds to the device 400 in FIG. 4; accordingly, the same or similar references have been used to indicate the same or similar features unless otherwise indicated. FIG. 14 illustrates, for example, a web client 1106 operating via a browser (e.g., such as the INTERNET EXPLORER® browser developed by Microsoft® Corporation of Redmond, Wash. State), and a programmatic client 1108 executing on respective client devices 1110 and 1112.

The network architecture 1400 may be utilized to execute any of the methods described in this document. The client devices 1110 and 1112 may comprise a mobile phone, desktop computer, laptop, or any other communication device that a user may utilize to access the networked system 1102. In some embodiments, the client device 1110 may comprise a display module (not shown) to display information (e.g., in the form of user interfaces). In further embodiments, the client device 1110 may comprise one or more of a touch screen, accelerometer, camera, microphone, and GPS device. The client devices 1110 and 1112 may be a device of a user that is used to perform a transaction involving digital goods within the networked system 1102. In one embodiment, the networked system 1102 is a network-based marketplace that manages digital goods, publishes publications comprising item listings of products available on the network-based marketplace, and manages payments for these marketplace transactions. Additionally, external sites 1128, 1128′ may be sites coupled to networked system 1102 via network 1104. External sites may be any desired system, including ecommerce systems.

An Application Program interface (API) server 1114 and a web server 1116 are coupled to, and provide programmatic and web interfaces respectively to, one or more application servers 1118. The application server(s) 1118 host a publication system 1200 and a payment system 1122, each of which may comprise one or more modules, applications, or engines, and each of which may be embodied as hardware, software, firmware, or any combination thereof. The application servers 1118 are, in turn, coupled to one or more database servers 1124 facilitating access to one or more information storage repositories or database(s) 1126. In one embodiment, the databases 1126 are storage devices that store information to be posted (e,g., publications or listings) to the publication system 1200. The databases 1126 may also store digital goods information in accordance with example embodiments.

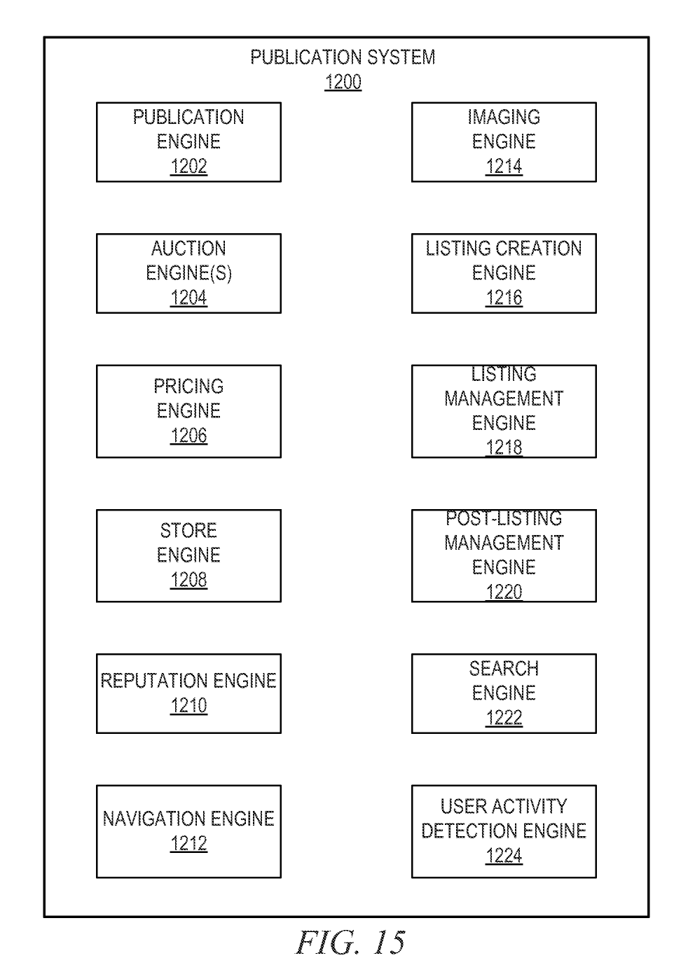

In example embodiments, the publication system 1200 publishes content on a network (e.g., Internet). As such, the publication system 1200 provides a number of publication and marketplace functions and services to users that access the networked system 1102. The publication system 1200 is discussed in more detail in connection with FIG. 15. In example embodiments, the publication system 1200 is discussed in terms of an online marketplace environment. However, it is noted that the publication system 1200 may be associated with a non-marketplace environment such as an informational (e.g., search engine) or social networking environment.

The payment system 1122 provides a number of payment services and functions to users. The payment system 1122 allows users to accumulate value (e.g., in a commercial currency, such as the U.S. dollar, or a proprietary currency, such as points, miles, or other forms of currency provide by a private entity) in their accounts, and then later to redeem the accumulated value for products (e.g., goods or services) that are made available via the publication system 1200 or elsewhere on the network 1104. The payment system 1122 also facilitates payments from a payment mechanism e.g., a bank account, PayPal™, or credit card) for purchases of items via any type and form of a network-based marketplace.

While the publication system 1200 and the payment system 1122 are shown in FIG. 14 to both form part of the networked system 1102, it will be appreciated that, in alternative embodiments, the payment system 1122 may form part of a payment service that is separate and distinct from the networked system 1102. Additionally, while the example network architecture 1400 of FIG. 14 employs a client-server architecture, a skilled artisan wilt recognize that the present disclosure is not limited to such an architecture. The example network architecture 1400 can equally well find application in, for example, a distributed or peer-to-peer architecture system. The publication system 1200 and payment system 1122 may also be implemented as standalone systems or standalone software programs operating under separate hardware platforms, which do not necessarily have networking capabilities.

Referring now to FIG. 15, an example block diagram illustrating multiple components that, in one embodiment, are provided within the publication system 1200 of the networked system 1102 is shown. In this embodiment, the publication system 1200 is a marketplace system where items (e.g., goods or services) may be offered for sale and that further implements the features described herein for interactive query generation and refinement. The items may comprise digital goods (e.g., currency, license rights). The publication system 1200 may be hosted on dedicated or shared server machines (not shown) that are communicatively coupled to enable communications between the server machines. The multiple components themselves are communicatively coupled (e.g., via appropriate interfaces), either directly or indirectly, to each other and to various data sources, to allow information to be passed between the components or to allow the components to share and access common data. Furthermore, the components may access the one or more databases 1126 via the one or more database servers 1124, as shown in FIG. 14.

FIG. 15 illustrates a publication system 1200 according to an embodiment of the present disclosure. FIG. 15, the publication system 1200 provides a number of publishing, listing, and price-setting mechanisms whereby a buyer may list (or publish information concerning) goods or services for sale, a buyer can express interest in or indicate a desire to purchase such goods or services, and a price can be set for a transaction pertaining to the goods or services. To this end, the publication system 1200 may comprise at least one publication engine 1202 and one or more auction engines 1204 that support auction-format listing and price setting mechanisms for (primary and/or secondary auctions.

A pricing engine 1206 supports various price listing formats. One such format is a fixed-price listing format (e.g., the traditional classified advertisement-type listing or a catalog listing). Another format comprises a buyout-type listing. Buyout-type listings (e.g., the Buy-It-Now (BIN) technology developed by eBay Inc., of San Jose, Calif.) may be offered in conjunction with auction-format listings and allow a buyer to purchase goods or services, which are also being offered for sale via an auction, for a fixed price that is typically higher than a starting price of an auction for an item.

A store engine 1208 allows a buyer to group listings within a “virtual” store, which may be branded and otherwise personalized by and for the buyer. Such a virtual store may also offer promotions, incentives, and features that are specific and personalized to the buyer. In one example, the buyer may offer a plurality of items as Buy-It-Now items in the virtual store, offer a plurality of items for auction, or a combination of both.

A reputation engine 1210 allows users that transact, utilizing the networked system 1102, to establish, build, and maintain reputations. These reputations may be made available and published to potential trading partners. Because the publication system 1200 supports person-to-person trading between unknown entities, in accordance with one embodiment, users may otherwise have no history or other reference information whereby the trustworthiness and credibility of potential trading partners may be assessed. The reputation engine 1210 allows a user, for example through feedback provided by one or more other transaction partners, to establish a reputation within the network-based marketplace over time. Other potential trading partners may then reference the reputation for purposes of assessing credibility and trustworthiness.

Navigation of the network-based marketplace may be facilitated by a navigation engine 1212. For example, a browse module (not shown) of the navigation engine 1212 allows users to browse various category, catalog, or inventory data structures according to which listings may be classified within the publication system 1200. Various other navigation applications within the navigation engine 1212 may be provided to supplement the browsing applications.

In order to make listings available via the networked system 1102 as visually informing and attractive as possible, the publication system 1200 may include an imaging engine 1214 that enables users to upload images for inclusion within publications and to incorporate images within viewed listings. The imaging engine 1214 may also receive image data from a user as a search query and utilize the image data to identify an item depicted or described by the image data.

A listing creation engine 1216 allows users e.g., buyers to conveniently author listings of items. In one embodiment, the listings pertain to goods or services that a user e.g., a buyer) wishes to transact via the publication system 1200. In other embodiments, a user may create a listing that is an advertisement or other form of publication.

A listing management engine 1218 allows the users to manage such listings. Specifically, where a particular user has authored or published a large number of listings, the management of such listings may present a challenge. The listing management engine 1218 provides a number of features (e.g., auto-relisting, inventory level monitors, etc.) to assist the user in managing such listings.

A post-listing management engine 1220 also assists users with a number of activities that typically occur post-listing. For example, upon completion of a transaction facilitated by the one or more auction engines 1204, a buyer may wish to leave feedback regarding a particular seller. To this end, the post-listing management engine 1220 provides an interface to the reputation engine 1210 allowing the buyer to conveniently provide feedback regarding multiple sellers to the reputation engine 1210. Another post-listing action may be shipping of sold items whereby the post-listing management engine 1220 may assist in printing shipping labels, estimating shipping costs, and suggesting shipping carriers.

A search engine 1222 performs searches for publications in the networked system 1102 that match a query. In example embodiments, the search engine 1222 comprises a search module (not shown) that enables keyword searches of publications published via the publication system 1200. Further, for example, the search engine 1222 may perform the functions previously described in reference to the search engine 121. In a further embodiment, the search engine 1222 may take an image received by the imaging engine 1214 as an input for conducting a search. The search engine 1222 takes the query input and determines a plurality of matches from the networked system 1102 (e.g., publications stored in the database 1126). It is noted that the functions of the search engine 1222 may be combined with the navigation engine 1212. The search engine 1222, in the publication system 1200, may perform the functionality previously described with respect to the search engine 121.

A user activity detection engine 1224 in FIG. 15 may monitor user activity during user sessions and detect a change in the level of user activity that, as discussed in more detail below, may predict that a user is about to make a purchase. The exact amount of change in the level of user activity may vary. A general guideline may be to monitor across multiple sessions and detect any significant increase over time (for example the activity level doubling or tripling in a short span), in one embodiment, when the user activity detection engine 1224 detects such a condition, the ecommerce system may make an intervention to provide content for display to the user in an effort to improve the probability that the user will make a purchase, and/or also to motive the user to make the purchase on the ecommerce system site instead of moving to a competitor site in search of a better purchase. Stated another way, activity over time and at different times before a purchase action provides an opportunity to personalize marketing to a user, based on time, by intervention as discussed above. Additional examples of including a temporal frame in that marketing personalization are discussed below.

Although the various components of the publication system 1200 have been defined in terms of a variety of individual modules and engines, a skilled artisan will recognize that many of the items can be combined or organized in other ways and that not all modules or engines need to be present or implemented in accordance with example embodiments. Furthermore, not all components of the publication system 1200 have been included in FIG. 15. In general, components, protocols, structures, and techniques not directly related to functions of exemplary embodiments (e.g., dispute resolution engine, loyalty promotion engine, personalization engines) have not been shown or discussed in detail. The description given herein simply provides a variety of exemplary embodiments to aid the reader in an understanding of the systems and methods used herein.

### Data Structures

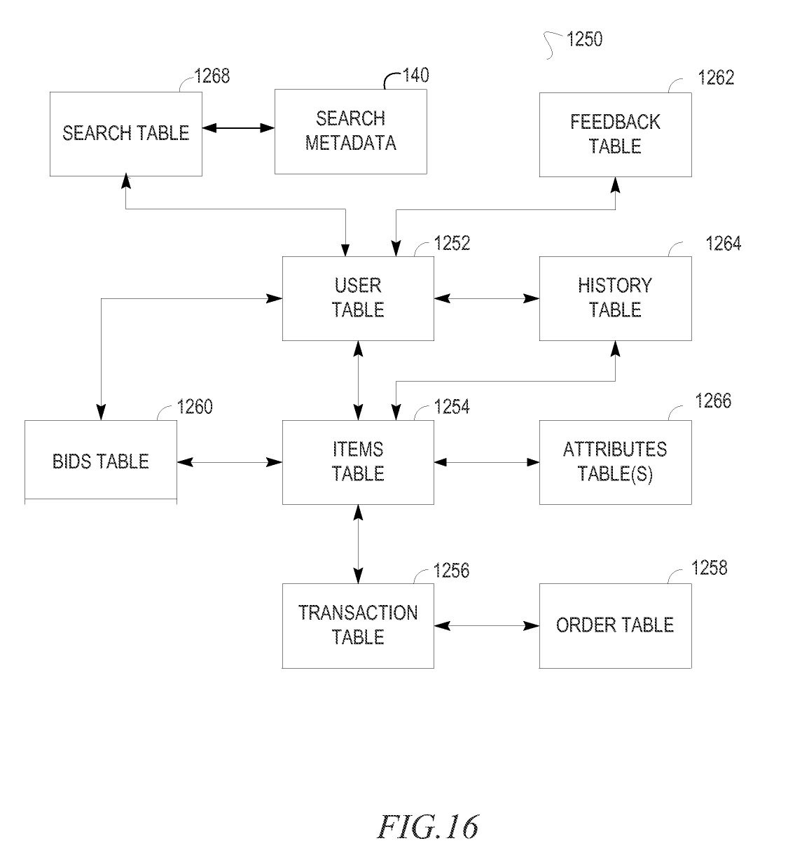

FIG. 16 is a high-level entity-relationship diagram, illustrating various tables 1250 that may be maintained within the databases 1126 of FIG. 14, and that are utilized by and support the publication system 1200 and payment system 1122, both of FIG. 14. A user table 1252 may contain a record for each of the registered users of the networked system 1402. A user may operate as a seller, a buyer, or both, within the network-based marketplace 1402. In one example embodiment, a buyer may be a user that has accumulated value (e.g., commercial or proprietary currency), and is accordingly able to exchange the accumulated value for items that are offered for sale by the network-based marketplace.

The tables 1250 may also include an items table 1254 in which item records (e.g., listings) are maintained for goods and services (e.g., items) that are available to be, or have been, transacted via the network-based marketplace. Item records (e.g., listings) within the items table 1254 may furthermore be linked to one or more user records within the user table 1252, so as to associate a seller and one or more actual or potential buyers with an item record (e.g., listing).

A transaction table 1256 may contain a record for each transaction (e.g., a purchase or sale transaction or auction) pertaining to items for which records exist within the items table 1254.

An order table 1258 may be populated with order records, with each order record being associated with an order. Each order, in turn, may be associated with one or more transactions for which records exist within the transaction table 1256.

Bid records within a bids table 1260 may relate to a bid received at the network-based marketplace in connection with an auction-format listing supported by the auction engine(s) 1204 of FIG. 15. A feedback table 1262 may be utilized by one or more reputation engines 1210 of FIG. 15, in one example embodiment, to construct and maintain reputation information concerning users in the form of a feedback score. A history table 1264 may maintain a history of transactions to which a user has been a party. One or more attributes tables 1266 may record attribute information that pertains to items for which records exist within the items table 1254. Considering only a single example of such an attribute, the attributes tables 1266 may indicate a currency attribute associated with a particular item, with the currency attribute identifying the currency of a price for the relevant item as specified by a seller. Another example of an attribute may include ‘fitment’ (compatibility) information, which facilitates an identification of compatibility of a part relative to other parts described in other listings.

A search table 1268 may store search information that has been entered by a user (e.g., a buyer) who is looking for a specific type of listing.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e,g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. As used herein, “processor-implemented module” refers to a hardware module in which the hardware includes one or more processors. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. :In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

We claim:

1. A system comprising:
an item module, implemented using one or more processors, configured to receive, from a potential seller of an item, a request to add the item to a secondary auction of items at a network-based marketplace;
a conditions module, implemented using one or more processors, configured to receive one or more seller conditions that apply to the item in the secondary auction, the conditions including at least one of price, delivery time, continuing availability, and a specific item property;
an auction module, implemented using one or more processors, configured to identify the secondary auction based on the item being compatible with other items in the secondary auction, the secondary auction of items being at a lower priority than a primary auction of items at the network-based marketplace, the auction module further adds the item to the secondary auction, the secondary auction being hidden from a buyer of the network-based marketplace until matching items in the primary auction fail to satisfy conditions of an offer received from the buyer; and
a notification module, implemented using one or more processors, configured to notify the seller in response to receiving an offer from the buyer that satisfies the seller conditions.

2. The system of claim 1, wherein the secondary auction is an aggregated auction for multiple distributed items that match the item.

3. The system of claim 1, further comprising an offer module, implemented using one or more processors, configured to receive an offer from the buyer that satisfies the seller conditions, and a presentation module, implemented using one or more processors, configured to display the auction to the buyer in response to receiving the offer.

4. The system of claim 3, wherein the offer comprises one or more buyer conditions, the notification module notifies the seller based on the seller satisfying the buyer conditions, the buyer conditions comprising at least one of a seller rating, a social connection between the seller and the buyer, seller expertise, and seller qualifications.

5. The system of claim 1, wherein the seller acquired the item in a previous auction, the auction module is further configured to add one or more details to the secondary auction based on details in the previous auction.

6. The system of claim 1, wherein the item comprises multiple parts, the auction module is further configured to determine separate secondary auctions for the multiple parts and adds the multiple parts to the secondary auctions.

7. The system of claim 1, wherein the auction module is further configured to convert the secondary auction to a primary auction in response to a request from the seller.

8. The system of claim 1, wherein the auction module is further configured to periodically request availability of the item from the seller.

9. The system of claim 1, wherein the notification module is further configured to notify the seller in response to a matching item being added to a primary auction at the network-based marketplace.

10. A method comprising:
receiving from a seller of an item, using one or more processors, a request to add the item to a secondary auction of items at a network-based marketplace;
receiving one or more seller conditions that apply to the item in the secondary auction, the conditions including at least one of price, delivery time, continuing availability, and a specific item property;
identifying the secondary auction based on the item being compatible with other items in the secondary auction, the secondary auction of items being at a lower priority than a primary auction of items at the network-based marketplace;
adding the item to the secondary auction, the secondary auction being hidden from a buyer of the network-based marketplace until availability of matching items in the primary auction of items falls below a threshold amount; and
notifying the seller in response to receiving an offer from the buyer that satisfies the conditions.

11. The method of claim 10, wherein the secondary auction is an aggregated auction for multiple distributed items that match the item.

12. The method of claim 11, wherein the offer comprises one or more buyer conditions, the notifying the seller is further based on the seller satisfying the buyer conditions, the buyer conditions comprising at least one of a seller rating, a social connection between the seller and the buyer, seller expertise, and seller qualifications.

13. The method of claim 10, wherein the seller acquired the item in a previous auction, the method further comprising adding one or more details to the secondary auction based on details in the previous auction.

14. The method of claim 10, wherein the item comprises multiple parts, the method further comprising adding the multiple parts to separate secondary auctions,

15. The method of claim 10, further comprising converting the auction in the secondary inventory to an auction in the primary inventory in response to a request from the seller.

16. The method of claim 10, further comprising periodically y requesting availability of the item from the seller.

17. The method of claim 10, further comprising notifying the seller in response a number of items in the auction falling below a threshold amount.

18. The method of claim 10, further comprising notifying the seller in response to a matching item being added to an auction in the primary inventory of items.

19. A machine-readable hardware storage device having no transitory signals storing a set of instructions that, when executed by a processor of a machine, cause the machine to perform operations comprising:
receiving from a seller of an item, using one or more processors, a request to add the item to a secondary auction of items at a network-based marketplace;
receiving one or more seller conditions that apply to the item in the secondary auction, the conditions including at least one of price, delivery time, continuing availability, and a specific item property;
identifying the secondary auction based on the item being compatible with other items in the secondary auction, the secondary auction of items being at a lower priority than a primary auction of items at the network-based marketplace;
adding the item to the secondary auction, the secondary auction being hidden from a buyer of the network-based marketplace until availability of matching items in the primary auction of items falls below a threshold amount; and
notifying the seller in response to receiving an offer from the buyer that satisfies the conditions.

20. The machine-readable hardware storage device of claim 19, wherein the offer comprises one or more buyer conditions, the notifying the seller is further based on the seller satisfying the buyer conditions, the buyer conditions comprising at least one of a seller rating, a social connection between the seller and the buyer, seller expertise, and seller qualifications
